(19) United States
(12) Patent Application Publication
(10) Pub. No.: US 2015/0187162 A1
(43) Pub. Date: Jul. 2, 2015

(54) CASINO GAMING TABLE TRACKING SYSTEM

(71) Applicant: Inotech Casino Solutions LLC, Parkland, FL (US)

(72) Inventors: James Lee, Parkland, FL (US); Marius Veldtman, Sherwood Park (CA)

(21) Appl. No.: 14/415,213

(22) PCT Filed: Jul. 16, 2013
(86) PCT No.: PCT/US2013/050654

§ 371 Date: Jan. 16, 2015

Related U.S. Application Data
(60) Provisional application No. 61/672,818, filed on Jul. 18, 2012.

(51) Int. Cl. G07F 17/32

(52) U.S. Cl. CPC G07F 17/322; G07F 17/3223; G07F 17/3293; G07F 17/3209; G07F 17/3251

(57) ABSTRACT

A gaming table tracking system has a master terminal with a processor; one or more slave terminals in communication with the master terminal, and a database. Each slave terminal has a processor, a player input device and a dealer input device, wherein wager transactions are entered using the player input device, and result transactions are entered using the dealer input device. The database tracks and stores gaming transactions and is connected to receive data from the master terminal and the one or more slave terminals. The wager and result transactions are communicated to the database.

### FIELD

This relates to a tracking system that may be used to track table games where wagering is involved.

### BACKGROUND

At gaming tables, there is generally a dealer, representing the house, and one or more players placing wagers. Common table games include Blackjack, Caribbean stud poker, 3 Card Poker, Roulette, etc. These games are commonly played by exchanging money for chips that represent money. These chips are used in the games for wagering purposes. Recently, there have been some systems developed to track wagers without the use of chips. One such system is produced by Digideal (www.digideal.com).

### SUMMARY

There is provided a gaming table tracking system, comprising a master terminal comprising a processor; one or more slave terminals in communication with the master terminal, and a database. Each slave terminal comprises a processor, a player input device and a dealer input device, wherein wager transactions are entered using the player input device, and result transactions are entered using the dealer input device. The database tracks and stores gaming transactions and is connected to receive data from the master terminal and the one or more slave terminals. The wager and result transactions are communicated to the database.

According to an aspect, the dealer input device may be on a side of the slave terminal facing a position of a dealer and may be separate and distinct from the player input device.

According to an aspect, the master terminal may further comprise a dealer input device for recording result transactions for each slave terminal.

According to an aspect, the database may be separate from the master terminal.

According to an aspect, the dealer input device of each slave terminal may comprise one of push buttons and a touch screen.

According to an aspect, there is provided a method of tracking game play comprising the steps of: providing a master terminal at a dealer's position, the master terminal comprising a processor, a slave terminal at one or more player's position, each slave terminal comprising a processor, a player input device and a dealer input device, the dealer input device being oriented toward the dealer's position relative to the player's position, and a database connected to receive data from the master terminal and the one or more slave terminals. Players enter wager transactions using the player input device during a game and the dealer enter a result transaction using the dealer input device at the end of the game, wherein the result transaction is communicated to the database.

According to an aspect, the master terminal may further comprise a dealer input device for recording the result transactions for each slave terminal that is separate and distinct from the player input device.

According to an aspect, the database may be separate from the master terminal or may be within the master terminal.

According to an aspect, the dealer input device of each slave terminal may comprise one of push buttons and a touch screen.

While the various combinations may not be explicitly described, the aspects described above and in the description below may be used together in any combination unless the aspects are mutually exclusive.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic view of a network of master and slave terminals.

FIG. 2 is a schematic view of a table having master and slave terminals.

FIG. 3 is a top plan view of a slave terminal.

FIG. 4 is a side elevation view of a slave terminal.

FIG. 5 is a front end elevation view of a slave terminal.

### DETAILED DESCRIPTION

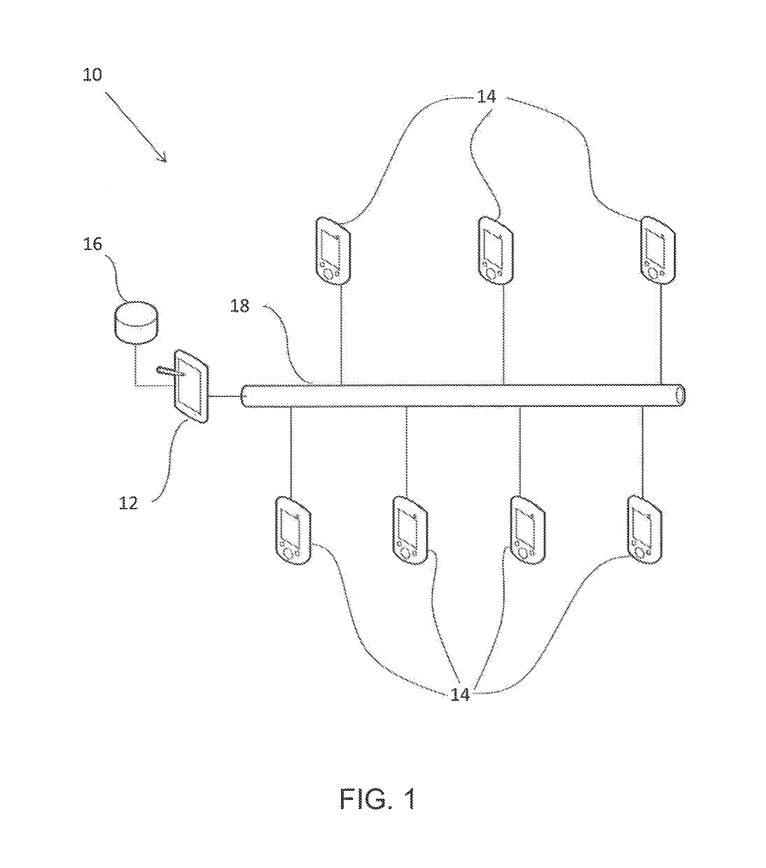

FIG. 1 shows a casino table tracking system, generally indicated by reference numeral 10. Casino table tracking system 10 is a table accounting system based on an interactive control system virtualizing chip betting at player locations while the dealer action remains the same for each game. This gives the system the ability to track the accounting functions at the table proving output options to the operators not currently available in the market. The game is played at a table 20 with cards, with system 10 being used to track bets and player winnings.

System 10 has a master device 12 and multiple slave devices 14. The number of slave devices may be modified according to the number of desired players for a game or table. As shown, seven slave devices 14 are connected to a central database 16 along with master device 12 via a secure network 18. Database 16 is shown as a separate component for illustrative purposes, but may be stored on a separate computing device, or may be located in master device 12 or one of the slave devices 14 connected to network 18. Database 16 may also be stored in the computer system of, for example, a casino. Network 18 may be a localized network related to a specific table 20, or may be part of a broader network such as may be found in a casino or other location. Devices 12 and 14 and database use computer processors, memory devices and the like in order to process and manage data. Different architectures are known and those skilled in the art will recognize how these may be implemented once the principles described herein are understood. For example, master and slave devices 12 and 14 may be indistinguishable based on their hardware configuration and the difference may be the software installed on each device, or the features or permissions allowed for on each device.

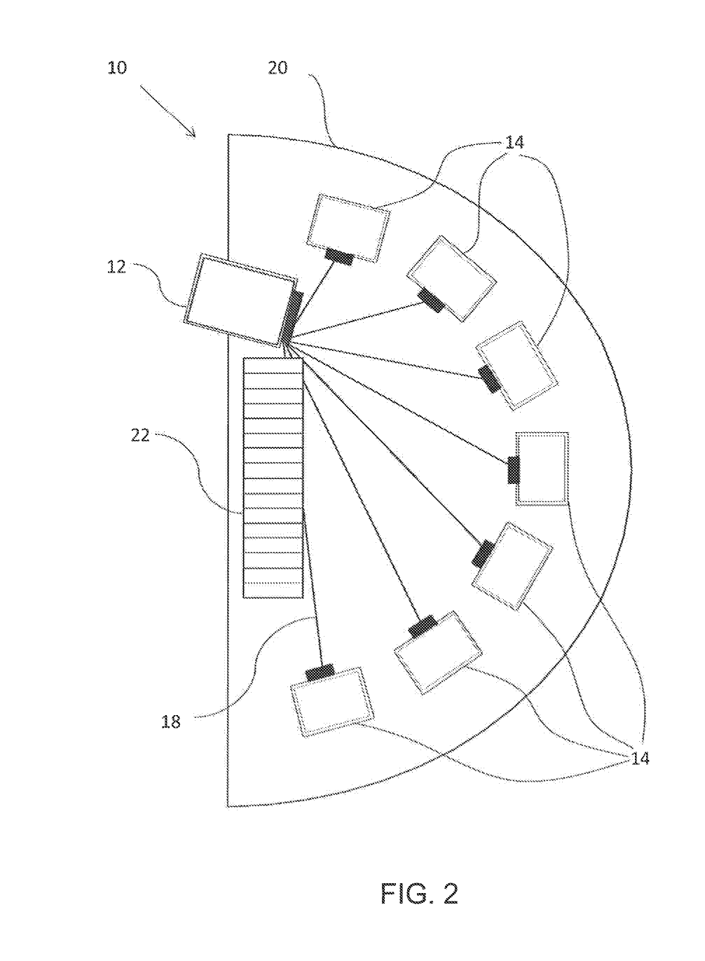

Prior to game play, specialized software on both master and slave devices 12 and 14 is installed to allow the operator to configure system 10 so that all slave devices 14 are connected to master device 12 in the seating order at the table 20, as shown in FIG. 2. Referring again to FIG. 1, once securely connected to the database a master and slave set of programs are opened on the corresponding devices 12 and 14 allowing for different applications at the master and slave devices. In FIG. 2, table 20 is shown as having a chip tray 22. However, when system 10 is in use, chip tray 22 is not necessary for the play of the game, although it may be used when a player cashes in or out.

Before access is granted to the master unit, the management team will assign user accounts with access privileges to each staff member. The dealer will log on to the master using their specific account information prior to having the ability to set up the table for play. Master terminal 12 is preferably programmed to allow the dealer overall control of the game, and allows for functions such as updating a player's information or status, adding money to a player's account, controlling the type or rules of the game being played, etc. Master terminal 12 may also give the dealer the ability to create player accounts, such as to which may be used for loyal clients who participates in special casino reward programs, which may then be accessed on a broader network in the casino. User account data may be entered manually or the dealer may make use of a card interface system 24 able to read magnetic strip or smart cards. The system will read the specific player information from the card and populate a specific field of information used to identify the player. Users without a player card may simply be identified as Guests and will not be eligible for rewards based on game play. Alternatively, a player may log into an account by entering a username and password. If a player has an account, the account may also have an associated financial balance. A player may also buy into a game using cash or to top up the financial balance of an account. The player may be entered at the master terminal by the dealer, or directly at the slave terminal. Each slave terminal 14 may also be equipped with a card reader to allow players to swipe their card directly, although this will increase the infrastructure costs.

Master terminal 12 is preferably programmed to allow the dealer to observe the various wagers or status of each player as the game progresses. As will be understood, master terminal 12 may take various forms, and may be programmed to provide as many or as few functions as desired. Master terminal 12 may have different levels of access, such that an administrator may be required to enter or change certain information related to the table. Each of the master terminal and the slave terminal comprises a processor as an internal component (not shown). The master terminal also includes, or is connected to, a database. The database may be stored within the master terminal, or may be located elsewhere, such as a centralized server. Master device 12 preferably contains a number of input/output control and setup programs which gives the casino operator and the dealer at the table 20 the ability to first select the game which will be played at the table before proceeding to actual game play. The type of game may be Blackjack, Caribbean stud poker, 3 Card Poker, Roulette or any other casino table game.

Once logged in, master device 12 may permit the dealer to select the game type, which will open the master software control screen for the specific game. Database 16 is used to record all transactions for the table such as games played, tips and reward points. A reporting tool may be provided on master device 12 to allow the dealer to pull reports on the history of game play and player activity.

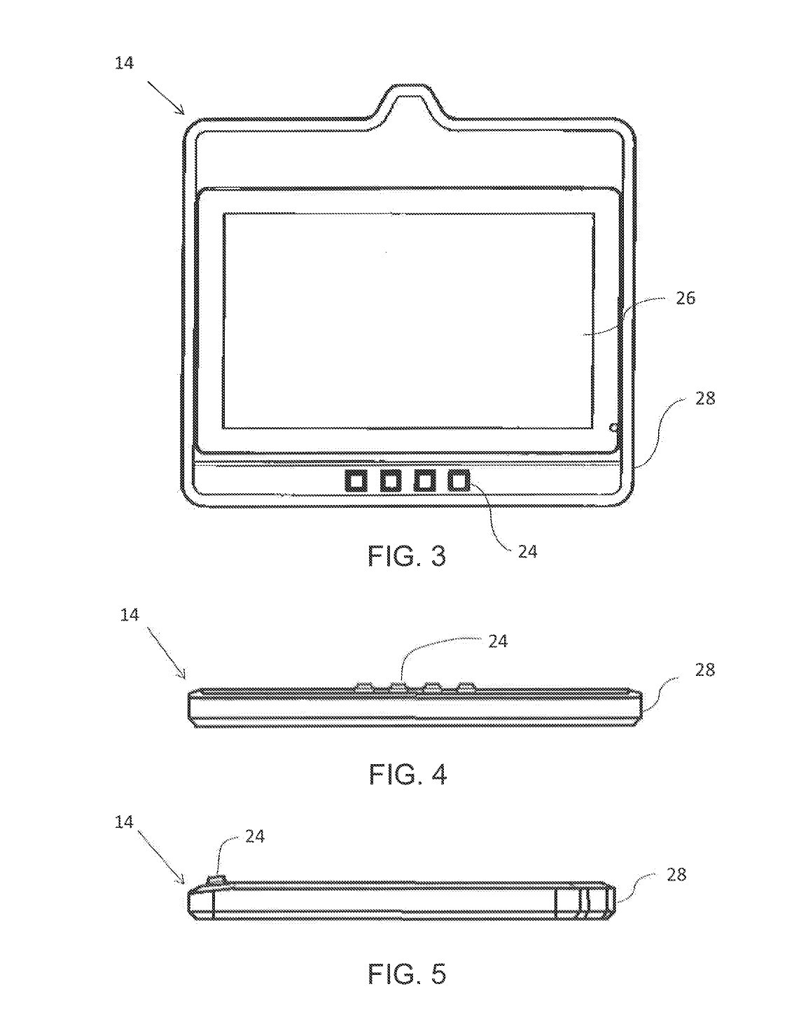

Referring to FIGS. 3-5, an example of a slave terminal 14 is shown with a series of inputs 24 adjacent to a display screen 26. Inputs 24 are preferably accessible to the dealer and face away from the players, which control the results of the game. With the depicted slave unit 14, buttons 24 at the bottom face the dealer while the top of the image faces the player. At the end of each hand, the dealer uses buttons 24 to indicate a win, loss, etc.

Display screen 26 is preferably a touch screen that allows players to place bets and enter other instructions. For example, display screen 26 may be a tablet computer within a housing 28 and inputs 24 are mounted on housing 28. Tablet computer 26 may be connected to inputs 24 by a USB connection, which is preferably hidden within housing 28. Tablet computer 26 may connect to network 18 using its internal wireless transceiver or by a wired connection.

Inputs 24 may take various forms as are known in the art, such as push-buttons, touch sensitive buttons, switches, dials, etc. Push buttons are preferred due to cost and reliability concerns. Inputs 24 generally include buttons for the various outcomes of a game. For example, in blackjack, there may be a button for win, lose, push, and blackjack. The number of buttons may be varied depending on the games that are intended to be tracked. For example, two sets of buttons may be provided to allow the player to play two hands or to track a play splitting in blackjack (alternatively, the results for a player that is playing more than one hand or that splits may be controlled at the master station by the dealer). The buttons may be reassigned to perform different functions as the game being played at a table is changed, or a portion of or the entire slave terminals may be exchanged when the game is changed.

Wagers are placed by the players using slave terminal 14 and the game progresses as it normally would, except that all wagering is entered electronically. Preferably, slave terminals 14 are touch sensitive screens, such as are available on tablet computers, to ensure optimal space usage on the table and to simplify interaction with the user. However, the slave terminals may also have other input methods as are known in the art. Once a hand or game is complete, the dealer enters the result of the game using the inputs on each slave terminal. The inputs on each slave terminal correspond to the results for that slave terminal. This may be done at the same time that the cards are collected if the game was a card game, and mimics the gathering or distribution of chips that would otherwise occur in a non-electronic tracking system. In one embodiment, a commercially available tablet was used, and a custom frame was installed around the tablet. The custom frame surrounded the tablet and included button inputs, which were connected to the tablet by a USB connection. Power and communication connections were also made through the custom frame. Custom software may be loaded onto the tablet using the tablet's operating system. Communication between the master terminal and the slave terminals may be wired or wireless.

One example of a game play procedure will now be discussed. Different procedures may also be followed, depending on the structure of system 10 and the preferences of the user. A player will approach the table 20 just like in a traditional setting, place their cash/player card/smart card or other method of payment on the table and request to join the game. If the player is not in the player database and wishes to join the casino player reward program, the dealer will open the player management application and add the player to the system. If the player is already in the system the dealer will simply swipe/scan their player card at the master device 12, add the amount the player wishes to join with, select their seat and activate the slave device 14 assigned to the seat.

At this time slave device 14 will become active and the table limits complete with the credits just purchased from the dealer will be displayed in the Credit Meter of the slave device 14. The user name will also be displayed on the unit and if the player is not assigned to the reward program it will simply indicate “Guest”. The same information will be displayed on the master unit configured to display the credit and user status for each active player at the table.

The players will now be asked to place their bets. Using the touch screen interface on the slave device they will select any domination chip and drag it on to the betting box or boxes until they reach the maximum table limit. Players will be warned if they reached the limit, trying to bet over the limit or if they do not have sufficient credits to complete the selected option. Just like in any traditional game, players will have the additional options “If available and configured” to bet two hands, side bets or tips for the dealer.

Upon completion of betting the dealer will indicate “No more Bets” and will select a “Deal” button on master unit 12 preventing any further betting on slave units 14. If an error occurs at any point in the game, the dealer has the ability to undo any past action for the entire game or just a selected seat depending on the game.

If the dealer is satisfied that all the players fully completed their bets, they will deal the game or spin the wheel just like in any traditional setting. Upon completion of the first action or hand, options may become available to the players or dealer. In the case of card game like Blackjack, the player will be presented with options like splitting their cards or double down. Like in a traditional setting, the player will make the request to the dealer and the dealer will select the requested option on master terminal 12 which in turn provides the options to the player on slave terminal 14. The player will complete the required action/input on slave terminal 14 and the dealer will deal the additional cards as required.

During or after game play, depending on the game, the dealer has the option to select a specific result for each player based on the outcome of the hand or game. Results are entered into the system by the dealer utilizing a set of pre-selected buttons 24 “Based on the specific game” located on the dealer side of each slave device. These buttons could be individual hard Open/Close press buttons or a digital display indicating buttons and are attached and or located on or near the slave device and not the master.

In the case of Blackjack, for example, a green button may be pressed for a win, red for a loss, yellow for a push and blue for a Blackjack. The result will be displayed on the slave unit 14 and the game information, credits and history updated accordingly. Results for special hands like spits and multiple hands are entered on master terminal 12.

The dealer will start at seat one and work their way around the table until all the results for the game is entered. At that time the dealer will turn to the master device 12 and select “Game Over”. The not game is now able to start.

A running total of reward points may be indicated on each slave device 14 where a player takes part in rewards program and is entered into the system. Points are rewarded based on total betting amounts and as per each operator's rewards program. A player, if they wish to do so, could at any time select the “Claim reward points” button and will automatically be credited the amount of points back in credits based on the pre-set rewards program.

If a player chooses to leave the game, they have to wait until the end of a game and select “Cash Out” on slave unit 14. The dealer will be prompted on master unit 12 that a player wishes to leave the game and will select “Accept” to complete the transaction. The dealer will then hand the player the outstanding amount in chips or it could be transferred back to a smart card or other device and transferred to another table or cash desk.

During play, master terminal 12 and the slave terminals 14 record and process various transactions. Wager transactions are generally entered by the player and include placing bets, splitting, and other steps during play. There may be other transactions, such as ordering service from the restaurant or bar, which may pass through the master terminal, or may be passed communicated through a separate network. If desired, wager transactions may also may be entered by the dealer using the master terminal. Result transactions are generally entered by the dealer, and include win, lose, push, etc. as the case may be, and depending on the game. Result transactions may be entered either using the buttons on the salve terminal or directly into the master terminal. It has been found that, by decentralizing the input of the result transactions, the speed of play is increased when compared with having the dealer enter the results directly into the master terminal.

The input by the players and the dealer cause the accounting system stored in database 16 to update the user's interface as it would if chips were being used. The player's total is increased in the event of a win, reduced in the event of a loss, etc. Preferably, inputs 24 provide some feedback when actuated, such as a visual or audio signal, to provide feedback to the players and the dealer to know the result of the game. It also notifies the dealer against any accidental or fraudulent use of the buttons. There may also be safeguards in the system itself such that the buttons can only be pressed, or input from the buttons will only be acknowledged, at certain points in the gameplay. Furthermore, master terminal 12 preferably has the ability to undo any wager or result transaction that may have been made in error. Master terminal 12 has an input that may be a touch screen, a keyboard, or any other known input method that is easy and efficient to use.

The visual display 26 of slave units 14 preferably mimics the layout of a table for ease of use, and uses images of chips to place wagers. Slave unit 14 allows a player to drag bets to certain areas for wagering. Display 26 may also allow the user to give gratuities to the dealer, order service from the bar or restaurant, etc.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include What is specifically illustrated and described above, what is conceptually equivalent, and what can be obviously substituted. The scope of the claims should not be limited by the preferred embodiments set forth in the examples, but should be given the broadest interpretation consistent with the description as a whole.

1. A gaming table tracking system, comprising:
a master terminal comprising a processor;
one or more slave terminals in communication with the master terminal, each slave terminal comprising a processor, a player input device and a dealer input device, wherein wager transactions are entered using the player input device, and result transactions are entered using the dealer input device;
a database for tracking and storing gaming transactions connected to receive data from the master terminal and the one or more slave terminals, wherein the wager and result transactions are communicated to the database.

2. The gaming table tracking system of claim 1, wherein the dealer input device is on a side of the slave terminal facing a position of a dealer and is separate and distinct from the player input device.

3. The gaming table tracking system of claim 1, wherein the master terminal further comprises a dealer input device for recording result transactions for each slave terminal.

4. The gaming table tracking system of claim 1, wherein the database is separate from the master terminal.

5. The gaming table tracking system of claim 1, wherein the dealer input device of each slave terminal comprises one of push buttons and a touch screen.

6. A method of tracking game play comprising the steps of: providing:
a master terminal at a dealers position, the master terminal comprising a processor;
a slave terminal at one or more player's position, each slave terminal comprising a processor, a player input device and a dealer input device, the dealer input device being oriented toward the dealer's position relative to the player's position; and
a database connected to receive data from the master terminal and the one or more slave terminals;
having the players enter wager transactions using the player input device during a game; and
having the dealer enter a result transaction using the dealer input device at the end of the game, wherein the result transaction is communicated to the database.

7. The method of claim 6, wherein the master terminal further comprises a dealer input device for recording the result transactions for each slave terminal that is separate and distinct from the player input device.

8. The method of claim 6, wherein the database is separate from the master terminal or is within the master terminal.

9. The method of claim 6 wherein the dealer input device of each slave terminal comprises one of push buttons and a touch screen.
